(19) United States
(12) Patent Application Publication
(10) Pub. No.: US 2022/0213622 A1
(43) Pub. Date: Jul. 7, 2022

(54) ULTRA LOW PERMEABILITY AND HIGH SEAM STRENGTH FABRIC AND METHODS OF MAKING THE SAME

(71) Applicant: INV PERFORMANCE MATERIALS, LLC, WILMINGTON, DE (US)

(72) Inventor: Neil HUNT, Glouscester (GB)

(21) Appl. No.: 17/605,254

(22) PCT Filed: Apr. 28, 2020
(86) PCT No.: PCT/IB2020/053963

§ 371 Date: Oct. 21, 2021

Related U.S. Application Data
(60) Provisional application No. 62/840,427, filed on Apr. 30, 2019.

(51) Int. Cl. D03D 1/02; B60R 21/235

(52) U.S. Cl. CPC D03D 1/02; B60R 21/235; D10B 2505/18; D10B 2331/02; D10B 2505/124; B60R 2021/23509

(57) ABSTRACT

An uncoated woven fabric of yarn formed from synthetic fibers woven in the warp direction and weft direction to form a top surface and a bottom wherein the fabric is treated in order to permanently modify the fabric surface structure such that fibrillous or apical structures extend approximately normal to the surface of the fabric, and at least a portion of the yarn on the top surface and/or at least a portion of the yarn on the bottom surface have warp and weft fibers which are melt fused together at their intersections, and a majority of the yarn on the top surface and/or a majority of the yarn on the bottom surface have fibers with a permanently modified cross-section that are fused together, is provided. Methods for production and use of this fabric in application to products such as automobile airbags, sailcloths, inflatable slides, temporary shelters, tents, ducts, coverings and printed media are also provided.

### FIELD OF THE INVENTION

The invention relates to uncoated woven fabric of yarns of synthetic fibers and methods for production and use of such fabric to produce products such as, but not limited to, airbags, sailcloth, inflatable slides, tents, ducts, coverings and printed media.

### BACKGROUND OF THE INVENTION

There is a continuing trend within the automotive industry to move to smaller and lighter vehicles. Correspondingly, less space is sometimes available for mandatory safety items such as airbags, while some of the airbags need to be physically larger to meet evolving automotive safety standards. This has led to the problematic situation of some airbag modules needing to be smaller while some airbags need to be larger. Methods have evolved which pack airbags at higher pressures and/or temperatures. While such methods result in an improvement in packability of the airbag within the module, they also tend to be expensive and add complexity to the airbag module manufacturing process.

To meet the requirements for effective inflation, airbag fabric must meet certain strength requirements and have the ability to resist the passage of air, which is defined by measures of air permeability. Therefore, it is desirable for woven nylon or polyester airbags to have a very low porosity and correspondingly low air permeability. While fabric properties, such as the linear density of the yarns, twist factors, weave construction and thickness and weight, all influence air permeability, it has often been necessary to add a coating or additional layer to airbag fabrics to meet industry standards.

However, not only is the coating process slow and laborious, the coatings themselves are expensive, thus making these airbags very costly. Further, coatings can hinder the foldability or packability of these fabrics, a necessary characteristic for airbags.

Where coatings are not used, in order to have sufficiently low permeability the airbag fabric generally needs to be woven in a higher construction, which adds to cost and weight, and again reduces packability.

When lower fabric constructions are used, and so the cover factor of the fabric falls, then fabric properties such as the edge comb resistance strength is reduced. This fabric property is believed to correlate with a cut and sewn airbags seam strength, and in trying to reduce the fabric cover factor there is a tendency during the design phase for airbag cushions to fail at the seam through seam opening, and fabric damage at the seam.

Furthermore, as coating is removed, and fabric construction is reduced, the fabric's ability to withstand the hot gases created during deployment is reduced. This is probably due to the fabric having a more open structure, and so greater ability for the warp and weft threadlines to move relative to each other, so creating a lower barrier to gas flow. An example of this may be that when a non-coated, low construction fabric is folded within an airbag module a crease is formed in the fabric. During deployment the creased section of the fabric may have a more open structure than the non-creased portions of the fabric, due to a relative movement of the warp and weft threadlines arising from the strained state at the crease. This more open structure will lead to a lower barrier to hot gas flow than the non-creased portions of the fabric, and so hot gas will preferentially flow through the more open structure.

Calendering of fabrics, as taught in WO 2017/079499 A1 and in WO 2018/204154 A1 lead to a profound and permanent reduction in permeability of fabrics, and the process conditions described therein have been carefully designed to prevent change of fabric tensile strength as a direct result of the calendering step. Fabrics produced from the teachings of these references have been useful in enabling the elimination of coating, and to some extent a reduction of fabric construction, for fabrics used in airbag cushions. This has led to lower costs and improved packability of airbag fabrics.

However, for some particular airbag cushions in order to eliminate coating, the fabric permeability, as measured by static air and dynamic air permeability (SAP &DAP), must approach zero, and an acceptable seam strength performance, and so an improved edge comb resistance strength is of greater importance than preventing some change in tensile strength.

For other airbag cushions, a fabric which is more stable to a relative movement between warp and weft threadlines before or during hot gas deployment, again in conjunction with an acceptable seam strength, and so improved edge comb resistance strength, is of primary importance.

There is a need in the art for additional very low permeability, high edge comb resistance strength, foldable fabrics that require a reduced amount of coating or no coating at all, and can be woven in a lower fabric construction, and which still meet critical performance standards, such as permanent low air permeability and sufficiently high tensile strength, as well as sufficiently high tear strength.

### SUMMARY OF THE INVENTION

The present invention relates to uncoated woven fabrics comprising yarns of synthetic fibers, and methods for production and uses of such fabrics.

In a first aspect, the present invention relates to an uncoated woven fabric comprising yarn formed from synthetic fiber woven in the warp direction and weft direction to form a top surface and a bottom surface, the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

In one embodiment of this first aspect, the warp yarn is different from the weft yarn by virtue of one or more differences in their physical properties (such as linear density) derived from one or more differences in the physical properties (such as linear density) of said synthetic fiber, wherein the fibers which form the warp yarn are chemically identical to the fibers which form the weft yarn. Preferably, the fibers which form the warp yarn are formed from a single polymer which is the same as the single polymer from which the fibers of the weft yarn are formed

In an alternative embodiment of this first aspect, the warp yarn is different from the weft yarn in that the chemical composition of the synthetic fibers of the warp yarn is different from the chemical composition of the synthetic fibers of the weft yarn. In this embodiment, the warp and weft yarns are made from the same class of polymer, wherein the polymeric materials which form the fibers of the warp and weft yarns exhibit a single melting phase. In this embodiment, the warp and weft yarns may, for instance, comprise blends of the same polymers at different blending ratios, or blends of different polymeric materials. It will be appreciated by the skilled person that such a difference in chemical composition may also result in a difference in physical properties between the warp and weft yarns.

In a second aspect, the present invention relates to uncoated woven fabric comprising yarn formed from the same synthetic fibers, formed from a single polymer, woven in the warp direction and weft direction to form a top surface and a bottom surface. In fabric of the present disclosure the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

In one embodiment of this second aspect, the present invention relates to uncoated woven fabric comprising yarn formed from the same synthetic fibers, formed from a single polymer, woven in the warp direction and weft direction to form a top surface and a bottom surface. In fabric of the present disclosure the fabric surface structure has fibrillous or apical structures extending approximately normal to the surface of the fabric, and at least a portion of the yarn on the top surface or at least a portion of the yarn on the bottom surface has warp and weft fibers which are melt fused together at their intersections, and a majority of the yarn on the top surface or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

In a third aspect, the present invention relates to an uncoated woven fabric comprising yarn formed from fibers of the same synthetic fiber formed from a single polymer, woven in the warp direction and weft direction to form a top surface and a bottom surface; wherein the fabric has a static air permeability (SAP) of 0.3 1/dm²/min or lower, preferably 0.2 1/dm²/min or lower, and the dynamic air permeability is 150 mm/sec or lower; wherein the tensile strength of the fabric in both the warp and weft directions is 1000 N or greater; wherein a 15-200× magnified image of the fabric surface structure shows fibrillous or apical structures extending approximately normal to the surface of the fabric.

It will be appreciated by the skilled person that the term “fiber” can be used in the art to refer either to a yarn or to the continuous filaments from which the yarn is made. In the present disclosure, it will be appreciated that the term “yarn” is used to refer to a bundle of fibers which is woven to produce a fabric, and the term “fiber” is used to refer to the continuous filaments from which the yarn is made.

Said apical structures are suitably disposed at least along the intersections of the warp yarns with the weft yarns, preferably such that an intersection exhibits one or more apical structure(s) along at least 80%, preferably at least 90%, preferably at least 95% of its length, and wherein at least 80%, preferably at least 90%, preferably at least 95% of all intersections on the or each surface of said woven fabric exhibits apical structures in such a way. An apical structure may be disposed continuously along an intersection. Alternatively, there may be a discontinuity in such apical structure along an intersection, in which case one or more apical structures may be disposed along an intersection. An apical structure may vary in its height along an intersection.

As used herein, the term “intersection” refers to a linear section of the woven fabric where a warp yarn meets the longitudinal edge of a weft yarn on a surface of the woven fabric, or where a weft yarn meets the longitudinal edge of a warp yarn on a surface of the woven fabric.

Said apical structures are preferably also disposed in a ring-like formation around a junction of said intersections, wherein at least 80%, preferably at least 90%, preferably at least 95% of all junctions on one surface of said fabric exhibit such ring-like apical structures. An apical structure may be disposed around a junction in a continuous ring-like formation. Alternatively, there may be a discontinuity in such an apical structure around a junction, in which case one or more apical structures may be disposed in a ring-like formation around a junction. An apical structure may vary in its height around a junction.

As is evident from the figures described hereinbelow, apical structures may also be present at discrete locations across the surface of the fabric but they are predominantly associated with and located at said intersections and junctions as described above. Preferably, at least 70%, preferably at least 80%, preferably at least 90% of all apical structures on a surface of the fabric are located along said intersections or in ring-like formations around said junctions.

The apical structures may vary in height and exhibit a height distribution. Of the apical structures above the 50th percentile, preferably at least 70%, preferably at least 80%, preferably at least 90%, preferably at least 99% of all apical structures on a surface of the fabric are located along said intersections or in ring-like formations around said junctions.

Such apical structures are visible in a 15-200× magnified image of the fabric surface structure, particularly an SEM image. It will be appreciated therefore that the apical structures are not visible with the naked eye.

The fabric preferably has a static air permeability (SAP) of 0.3 1/dm²/min or lower, for example, 0.2 1/dm²/min or lower, a dynamic air permeability (DAP) of 150 mm/s or lower, and the tensile strength of the fabric in both the warp and weft directions is 1000 N or greater.

The fabric can have an edge comb resistance strength of 400N or greater.

In a fourth aspect, the present invention relates to an article formed from the uncoated woven fabrics of the first, second or third aspects of the present invention. Examples of articles include, but are not limited to, products such as airbags, sailcloth, inflatable slides, tents, ducts, coverings and printed media.

In a fifth aspect, the present invention relates to an airbag formed from the uncoated woven fabrics of the first, second or third aspects of the invention.

In a sixth aspect, the invention relates to a method of forming an uncoated woven fabric of the first aspect of the invention.

In a seventh aspect, the present invention relates to a method of forming an uncoated woven fabric of the second or third aspects of the invention. This method of the present invention comprises weaving yarn formed from the same synthetic fibers, formed from a single polymer, wherein a single polymer is defined as single polymer or a homogeneous blend that does not have bicomponent characteristics in its melting behavior—in that it has a single melting phase.

In each of the sixth and seventh aspects, yarn formed from said synthetic fibers is woven in the warp direction and weft direction to form a fabric with a top surface and a bottom surface. The fabric is then treated in order to permanently modify it such that the surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

In one non-limiting embodiment, the fabric formed has a static air permeability (SAP) of 0.3 1/dm²/min or lower, for example, 0.2 1/dm²/min or lower, the fabric formed has a dynamic air permeability (DAP) of 150 mm/s or lower, and the tensile strength of the formed fabric in both the warp and weft directions is reduced in comparison to the untreated fabric but is 1000 N or greater.

In an eighth aspect, the present invention relates to an article formed from the fabric formed in the methods of the sixth or seventh aspects. Examples of articles include but are not limited to products such as airbags, sailcloth, inflatable slides, tents, ducts, coverings and printed media.

In a ninth aspect, the present invention relates to an airbag formed from the fabric formed in the methods of the sixth or seventh aspects.

### BRIEF DESCRIPTION OF THE DRAWINGS

The accompanying drawings illustrate exemplary embodiments of the present disclosure, and together with the general description given above and the detailed description given below, serve to explain, by way of example, principles of the present disclosure.

FIGS. 1A through 1D are SEM images comparing the surfaces and cross section of a non-treated and HTHP treated fabric woven from 100% nylon 66 fabric made from 470 dtex, 136 filament (fiber), high tenacity yarn.

FIGS. 2A through 2D are SEM images at ca. 15 to 200× magnifications showing the surface and cross-sectional structure of a fabric which has been HTHP treated at enhanced conditions to minimize permeability, reduce tensile strength to a value of no less than 1000N, and maximize edge comb resistance strength.

### DETAILED DESCRIPTION OF THE INVENTION

The present invention relates to uncoated woven fabrics comprising yarns of synthetic fibers, and methods for production and uses of such fabrics.

The present invention particularly relates to uncoated woven fabric comprising yarn formed from the same synthetic fibers, formed from a single polymer, wherein a single polymer is defined as single polymer or a homogeneous blend that does not have bicomponent characteristics in its melting behavior—in that it has a single melting phase. As noted above, this is a requirement of the second, third and seventh aspects of the invention.

Yarns formed from said synthetic fibers are woven in the warp direction and weft direction to form a top surface and a bottom surface. In fabric of the present disclosure the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

The fabric has a static air permeability (SAP) of 0.3 1/dm²/min or lower, for example, 0.2 1/dm²/min or lower, a dynamic air permeability (DAP) of 150 mm/s or lower, and the tensile strength of the fabric in both the warp and weft directions is reduced in comparison to the untreated fabric but is 1000 N or greater.

The fabric has an edge comb resistance strength of 400N or greater.

The present invention further relates to an article formed from the uncoated woven fabric. Examples of articles include, but are not limited to, products such as airbags, sailcloth, inflatable slides, tents, ducts, coverings and printed media.

The present invention further relates to an airbag formed from the uncoated woven fabric.

The present invention further relates to a method of forming an uncoated woven fabric. The method of the seventh aspect of the present invention comprises weaving yarn formed from the same synthetic fibers, formed from a single polymer, in the warp direction and weft direction to form a fabric with a top surface and a bottom surface. The fabric is then treated in order to permanently modify the fabric, such that the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric. Similarly, the method of the sixth aspect of the present invention comprises weaving yarn formed from synthetic fibers in the warp direction and weft direction to form a fabric with a top surface and a bottom surface, followed by a said treatment in order to permanently modify the fabric.

In one non-limiting embodiment, the fabric formed has a static air permeability (SAP) of 0.3 1/dm²/min or lower, for example, 0.2 1/dm²/min or lower, the fabric formed has a dynamic air permeability (DAP) of 150 mm/s or lower, and the tensile strength of the formed fabric in both the warp and weft directions is reduced in comparison to the untreated fabric but is 1000 N or greater.

The present invention further relates to an article formed from the fabric formed in these methods. Examples of articles include but are not limited to products such as airbags, sailcloth, inflatable slides, tents, ducts, coverings and printed media.

The present invention further relates to an airbag formed from the fabric formed in these methods.

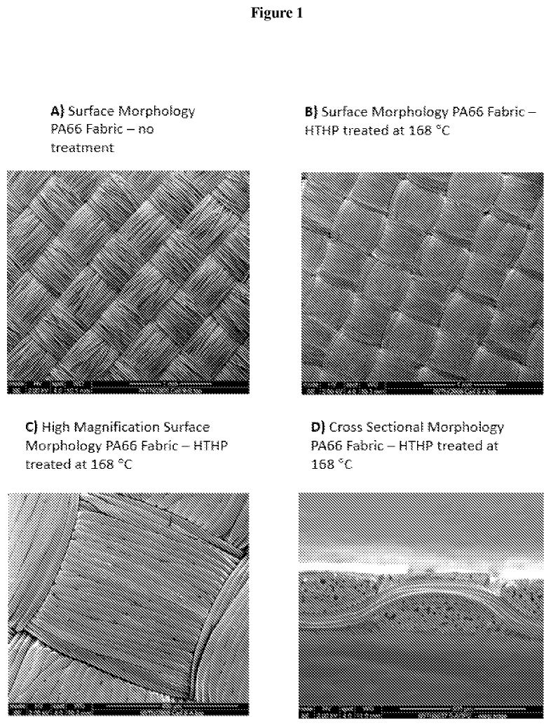

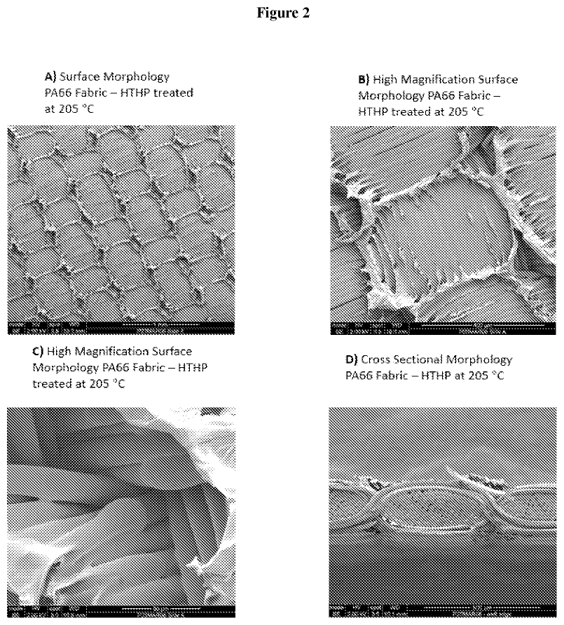

The term “permanently modified cross-section,” as used herein, refers to a fiber cross section that is a modified or compressed version of the cross section of the majority of the fiber used in the fabric. The fiber may have any cross-section known in the art, including but not limited to circular, multi-lobal, tri-lobal, hexa-lobal or rectangular. In one non-limiting embodiment, the fiber has a circular cross-section. In one non-limiting embodiment, the permanently modified cross-section results in at least a portion of the fiber being substantially flat. See FIGS. 1A through 2D.

The fibers may also have oval cross-sections. Taking the cross-sectional height divided by the cross-sectional width of the fiber as the aspect ratio, a flat fiber would have an aspect ratio approaching zero and a round cross-section fiber would have an aspect ratio of 1. Thus the fibers of the disclosed fabrics can suitably have aspect ratios of ≥0 to ≤1, for example≥0.1 to ≤0.9; for example≥0.2 to ≤0.8; for example≥0.3 to ≤0.7; for example≥0.4 to ≤0.6.

The term “permanent” or “permanently”, as used herein, means the modified cross-section does not revert to its original shape.

The phrase “yarn on the top surface” means a fiber bundle (yarn) that is visible from a point spaced apart from the surface, where the point falls on an imaginary line normal to the upper surface of a fabric.

The phrase “yarn on the bottom surface” means a fiber bundle (yarn) that is visible from a point spaced apart from the surface, where the point falls on an imaginary line normal to the lower surface of a fabric.

The term “yarn formed from fibers of the same synthetic fiber formed from a single polymer, woven in the warp and weft direction” as used herein means that the warp yarn is formed from synthetic fibers which are the same as the synthetic fibers from which the weft yarn is formed, wherein said synthetic fiber is formed from a single polymer (which is defined herein as a single polymer or a homogenous blend of polymers with a single melting phase).

In the second, third and seventh aspects of the present invention, all yarns in the fabric are made from the same synthetic fibers formed from a single polymer (as defined herein).

In one embodiment of the second, third and seventh aspects of the present invention, the warp yarn and the weft yarn are made from identical yarn.

In an alternative embodiment of the second, third and seventh aspects of the present invention, the warp yarn and the weft yarn are different, in that they exhibit one or more differences in their physical properties (such as linear density) while still being made from the same synthetic fibers (i.e. the synthetic fibers used to make the warp and weft yarns are chemically and physically identical).

The term “same class of polymer” means that the synthetic polymeric material of the warp yarn contains the same functional groups, in particular amide linkages, as the synthetic polymeric material of the weft yarn.

The term “the polymeric materials which form the fibers of the warp and weft yarns exhibit a single melting phase” means that the combined polymeric material of the warp and weft yarns exhibits a single melting phase, i.e. the combined polymeric material does not have bicomponent characteristics in its melting behavior.

The term “warp and weft fibers which are melt fused together at their intersections” means that, where the warp fibers intersect with the weft fibers, at least a portion of the warp fibers are melt fused with the intersecting weft fibers on the top and/or bottom surface of the woven fabric.

The term enhanced “High Temperature-High Pressure (HTHP)” treated as used herein, refers to treating the fabric at a selected temperature and/or selected pressure so that the fabric surface structure has fibrillous or apical structures extending approximately normal to the surface of the fabric, and at least a portion of the yarn on the top surface and/or at least a portion of the yarn on the bottom surface have warp and weft fibers which are melt fused together at their intersections, and a majority of the yarn on the top surface and/or a majority of the yarn on the bottom surface have fibers with a permanently modified cross-section that are fused together.

It had been previously believed that HTHP treatment of a fabric should be carried out at process conditions below the softening point of the filaments, and that calendering a fabric at elevated temperatures close to the melting point of the yarn would result in thermally induced mechanical degradation of the fabric, a decrease in fabric tensile and tear strength, a resultant poor dimensional stability and a significant increase in stiffness. For example, previous attempts with high temperature and high pressure calendering of woven fabrics led to a paper-like stiff product and did not result in desirable fabric properties for use in applications such as airbag fabrics. However, calendering of fabrics, as taught in WO 2017/079499 A1 and in WO 2018/204154 A1 showed that by processing with specific conditions above the softening point of the filaments, that the fabric permeability could be significantly and permanently reduced and that fabric tensile strength could be maintained. In this present disclosure the inventors have unexpectedly discovered that by carrying out HTHP treatment under specific conditions, the fabric permeability may be further reduced and the edge comb resistance of the fabric may be further increased, and although the tensile strength reduced in comparison to the untreated fabric, that such a balance of properties is appropriate for specific applications.

Conventional HTHP treatment of fabrics is carried out as a dry process with the calendering rolls temperature significantly below the softening point of the fibers within the fabric. This is so that the process can operate without melting of fibers onto the calender rolls, and to specifically avoid reducing the tensile strength and the tear strength of the fabric. The author has discovered that by using a wet calender process at temperatures which result in the fabric being HTHP treated above the fiber softening point, that the fabric may be processed without melting of fibers on the calender rolls, and that although the fabric tensile and tear strength is reduced more than in a conventional calendering process, they remain above values which are required for adequate functionality as an airbag, and that the significant reduction in permeability and increase in edge comb resistance of the fabric are useful for specific airbag applications.

Reference herein to a “wet calender process” is to the presence of a heat transfer fluid, for instance as taught in WO-2018/204154-A. The heat transfer fluid may be a liquid or a vapour, which may be added during the HTHP treatment step or is added in a prior step of the fabric production process and retained by the yarn. In one non-limiting embodiment, the presence of a heat transfer fluid results from the carry-over of residual moisture introduced by weaving with a water jet loom, or from a washing or scouring process, or from a dyeing process. Preferably, the heat transfer fluid is or comprises water, or is predominantly water. Where the heat transfer fluid is a vapour, it may be or predominantly be or comprise steam. The heat transfer fluid may be applied by a bath, or by a foulard liquid application system or by a liquid spray system or by a vapor phase application system. The heat transfer fluid should be inert or benign so as not to damage the fabric, and may be any liquid or vapor fitting that description. Preferably, the heat transfer fluid is present in an amount of from 5 to 30, preferably from 10 to 20%, based on the weight of the dry fabric.

The preferred synthetic fibers used in the present invention are formed from polyamides, and blends or copolymers thereof.

Suitable polyamide fibers include those formed from nylon 6,6, nylon 6, nylon 6,12, nylon 7, nylon 12, nylon 4,6 or copolymers or blends thereof, preferably nylon 6,6. Thus, in one preferred but non-limiting embodiment of the present invention, the base yarn is formed from a nylon 6,6 fiber.

The fiber used in the present invention may also comprise various additives used in the production and processing of fibers. Suitable additives include, but are not limited to a thermal stabilizer, antioxidant, photo stabilizer, smoothing agent, antistatic agent, plasticizer, thickening agent, pigment, flame retarder, filler, binder, fixing agent, softening agent or combinations thereof.

In one preferred but non-limiting embodiment, the fibers have a linear density in the range from about 1 to about 25 decitex per filament (DPF). In another preferred but non-limiting embodiment, the fibers have a linear density in the range from about 2 to about 12 decitex per filament (DPF).

The woven fabrics of the present invention may be formed from warp and weft yarns using weaving techniques known in the art. Suitable weaving techniques include, but are not limited to a plain weave, twill weave, satin weave, modified weaves of these types, one piece woven (OPW) weave, or a multi-axial weave. Suitable looms that can be used for weaving include a water jet loom, air jet loom or rapier loom. These looms can also be used in conjunction with a jacquard in order to create an OPW structure. Suitable woven fabrics of the present invention may have a total base weight in the range of 50 to 500 grams per square meter.

The independent process variables which are adjusted to obtain the disclosed combinations of fabric properties are;
a. Primary control variable is HTHP temperature or calendar roll temperature
   i. Broad range of 180° C. to 240° C.
   ii. Medium range of 195° C. to 230° C.
   iii. Narrow range of 200° C. to 225° C.
   iv. Narrower range of 202 to 220° C.
   v. Narrower range of 202 to 215° C.
   vi. Narrower range of 202 to 210° C.
b. Secondary control parameters include:
   i. Calender Nip Roll Force (100 to 500 N/mm, particularly 250-450 N/mm)
   ii. HTHP pressure or calender pressure (14 to 72 MPa, particularly 35-70 MPa, more particularly 40-60 MPa)
c. HTHP or calender roll speed (5 to 30 m/min, particularly 10-20 m/min)
d. the presence of a heat transfer liquid or vapor added during the fusing step or added in a prior step of the fabric production process and retained by the fibers, such that said heat transfer fluid is present during the treating process in an amount of 3 to 30 weight %, preferably 10-20 weight %, by weight of the fabric; preferably the heat transfer fluid is water which is present during, or is added to the fabric during or before (typically during), the HTHP process in an amount of 3 to 30 weight %, preferably 10-20 weight %.

In a preferred embodiment, the HTHP process conditions are:
a. an HTHP temperature or calender roll temperature in the range of 202 to 220° C., preferably 202 to 215° C., preferably 202 to 210° C.; and
b. an HTHP pressure or calender pressure in the range of 14 to 72 MPa, particularly 35-70 MPa, more particularly 40-60 MPa; and
c. preferably a calender nip roll force of 100 to 500 N/mm, particularly 250-450 N/mm; and
d. preferably an HTHP or calender roll speed of to 30 m/min, particularly 10-20 m/min; and
e. the presence of a heat transfer liquid or vapor added during the fusing step or added in a prior step of the fabric production process and retained by the fibers, such that said heat transfer fluid is present during the treating process in an amount of 3 to 30 weight %, preferably 10-20 weight %, by weight of the fabric, preferably wherein water is present during, or is added to the fabric during or before (typically during), the HTHP process in an amount of 3 to 30 weight %, particularly 10-20 weight %, by weight of the fabric.

In one non-limiting embodiment of the present invention, the woven fabric has a static air permeability (SAP) of 0.3 1/dm²/min or lower, preferably 0.2 1/dm²/min or lower, a dynamic air permeability (DAP) of 150 mm/s or lower and a tensile strength of the fabric in both the warp and weft directions of 1000 N or greater.

The following table illustrates the processing conditions suitable for performing the invention, and exemplified in the worked examples described hereinbelow. The first column represents the typical processing conditions disclosed in WO 2018/204154 A1, while the second column represents the modified processing conditions suitable for working the present invention. The third and fourth columns represent less desirable processing conditions which, while achieving apical structures, do not result in the preferred and most desirable permeability and tear strength properties, as illustrated in the worked examples hereinbelow.

| | Process | | Process | Process |
|---|---|---|---|---|
| | setting— | Process | setting— | setting— |
| | broad | setting— | narrow range | narrow range |
| Process parameter | range | optimized | (lower limit) | (upper limit) |
| HTHP temp (° C.) | 168 | 205 | 200 | 225 |
| HTHP nip roll force | 300 | 300 | 300 | 300 |
| (N/mm) | | | | |
| HTHP pressure | 43 | 43 | 43 | 43 |
| (MPa) | | | | |
| HTHP process | 15 | 15 | 15 | 15 |
| speed (m/min) | | | | |
| Water addition | 15 | 15 | 15 | 15 |
| (wt %) | | | | |
| Apical structure | No | Yes | Yes | Yes |
| Properties within | No | Yes | No | No |
| preferred limits | | | | |

In one non-limiting embodiment, the basis weight of the fabric is in the range from about 50 to about 500 g/m².

In one non-limiting embodiment, the tear strength of the fabric in both the warp and weft directions is 60 N or greater when the fabric is unaged. In another non-limiting embodiment, the tear strength of the fabric in both the warp and weft directions is 120 N or greater when the fabric is unaged.

In one non-limiting embodiment, the edgecomb resistance of the fabric in both the warp and weft directions is 400 N or greater.

In a tenth aspect, the invention relates to coated woven fabrics. In this aspect the woven fabric corresponds to woven fabric described hereinabove in respect of the aspects of the invention which relate to uncoated woven fabrics. In other words, the materials and manufacturing methods and characteristics and all preferences disclosed hereinabove for the uncoated woven fabrics apply also to the coated woven fabrics. Thus, the fabrics disclosed herein may be coated to provide additional properties, including, for example, a reduction in air permeability. If the fabrics are coated, then any coating, web, net, laminate or film known to those skilled in the art may be used in impart a decrease in air permeability or improvement in thermal resistance. Examples of suitable coating include, but are not limited to polychloroprene, silicone-based coatings, polydimethylenesiloxane, polyurethane and rubber compositions. Examples of suitable webs, nets and films include but are not limited to polyurethane, polyacrylate, polyamide, polyester, polyolefins, polyolefin elastomers and blends and copolymers thereof. Films may be single or multilayer and may be comprised of any combination of webs, nets or films. In these embodiments, fabric of the current invention may be used as a lower permeability substrate than fabrics with the same construction coated with a conventional amount of coating, film or laminate. This will allow for a lower weight coating, or a lighter or simplified web, net, laminate or film structure to be applied, and still meet very low permeability specifications. In one non-limiting embodiment, where such a coating, web, net, laminate or film is used, then it is present at a lower weight than used in conventional coated woven fabrics, and particularly in an amount of less than 10 wt %, preferably less than 9 wt %, preferably less than 8 wt %, preferably less than 7 wt % by total weight of the fabric, and typically at least 4 wt %, typically at least 5 wt % by total weight of the fabric, for instance in the range of from 4 to 7 wt % by total weight of the fabric.

Fabrics of the present invention produced in accordance with these methods meet mechanical and performance standards while limiting overall fabric weight and cost. Further, the fabrics of the present invention retain good packability.

Also provided in the present invention are articles formed from the woven fabrics and methods for their production disclosed herein. In one non-limiting embodiment of the present invention, the fabric is used to produce a product such as an automobile airbag, a sailcloth, inflatable slides, temporary shelters, tents, ducts, coverings and printed media. The term airbags, as used herein, includes airbag cushions. Airbag cushions are typically formed from multiple panels of fabrics and can be rapidly inflated. Fabric of the present invention can be used in airbags sewn from multiple pieces of fabric or from a one piece woven (OPW) fabric. One Piece Woven (OPW) fabric can be made from any method known to those skilled in the art.

As will be understood by the skilled artisan upon reading this disclosure, alternative methods and apparatus to those exemplified herein are available, and use thereof is encompassed by the present invention such that the fabric surface structure has fibrillous or apical structures extending approximately normal to the surface of the fabric, and at least a portion of the yarn on the top surface or at least a portion of the yarn on the bottom surface has warp and weft fibers which are melt fused together at their intersections, and a majority of the yarn on the top surface or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and non-limiting.

### Test Methods

All of the test standards & methods are to ASTM or ISO methods with specific amendments.

The Dynamic Air Permeability (DAP or ADAP) is defined as the average velocity (mm/s) of air or gas in the selected test pressure range of 30-70 kPa, converted to a pressure of 100 kPa (14.2 psi) and a temperature of 20° C. Another parameter, the curve exponent E (of the air permeability curve), is also measured automatically during Dynamic Air Permeability testing but this has no units. Dynamic Air Permeability is tested according to test standard ASTM D6476 but with the following amendments:
1. The limits of the measured pressure range (as set on the test instrument) are 30-70 kPa
2. The start pressure (as set on the test instrument) is to be adjusted to achieve a peak pressure of 100+/−5 kPa.
3. The test head volume will be 400 cm³ unless the specified start pressure cannot be achieved with this head, in which case one of the other interchangeable test heads (volumes 100, 200, 800 & 1600 cm³) should be used as is found to be appropriate for the fabric under test.
4. Dynamic Air Permeability testing will be done at six sites on a test fabric in a sampling pattern across and along the fabric in order to test 6 separate areas of warp and weft threadlines within the fabric.
5. The reported Dynamic Air Permeability result is the mean value of the six DAP measurements in units of mm/second.
6. The reported curve exponent (E) result is the mean value of the six curve exponent measurements (no units apply).

The Static Air Permeability (SAP—in units of 1/dm²/min) is tested according to test standard ISO 9237 but with the amendments as listed below:
1. The test area is 100 cm²
2. The test pressure (partial vacuum) is 500 Pa.
3. Each individual test value is corrected for edge leakage.
4. Static Air Permeability testing will be done at six sites on a test fabric in a sampling pattern across and along the fabric in order to test 6 separate areas of warp and weft threadlines within the fabric.
5. The reported Static Air Permeability result is the mean value of the six corrected measurements in units of 1/dm²/min

Fabric tensile testing, measuring both maximum force (N) & elongation at maximum force (%), is tested according to standard ISO 13934-1 but with the amendments as listed below:
1. The initial gauge (clamp) length set on the Instron tensile tester is 200 mm
2. The Instron crosshead speed is set at 200 mm/min
3. Fabric specimens are cut initially to size 350×60 mm but are then frayed down by unravelling the long edge threadlines to a testing width of 50 mm.
4. Tensile testing is done on 5 warp direction & 5 weft direction specimens cut from each test fabric in a diagonal cross pattern & avoiding any areas within 200 mm of the fabric selvedges.
5. The reported result for maximum force (also known as breaking force or breaking load) is the mean average of the maximum force results of the five warp direction specimens & (separately) the five weft direction specimens which were tested in Newtons (N).
6. The reported result for elongation at maximum force (also known as percentage elongation or percentage extension) is the mean average of the elongation at maximum force results of the five warp direction specimens & (separately) the five weft direction specimens which were tested (%).

Tear force (also known as tear strength)—in Newtons (N) is tested according to standard ISO 13937-2 but with the amendments as listed below:
1. The fabric specimen size is 150 mm×200 mm (with a 100 mm slit extending from the midpoint of the narrow end to the center.
2. Tear testing is done on 5 warp direction & 5 weft direction specimens cut from each test fabric in a diagonal cross pattern & avoiding any areas within 200 mm of the fabric selvedges.
3. Warp direction tear results are obtained from tested specimens where the tear is made across the warp (i.e. warp threadlines are torn) whilst weft direction results are obtained from tested specimens where the tear is made across the weft (i.e. weft threadlines are torn).
4. Each leg of the specimens is to be folded in half to be secured in the Instron clamp grips according to ISO 13937-2 annex D/D.2
5. Evaluation of test results is according to ISO 13937-2 section 10.2 “Calculation using electronic devices”.

The reported result for warp tear force is the mean average of the tear force results of the five warp direction specimens in Newtons (N), whilst for weft tear force it is the mean average of the tear force results of the five weft direction specimens.

Edgecomb resistance testing (also known as edge pullout testing)—in Newtons (N) is tested according to standard ASTM D6479 but with the amendments as listed below:
1. The edge distance shall be 5 mm—this is the distance between the end of the test specimen (which during testing is positioned on a narrow ledge machined in the test specimen holder) & the line of pins which perform the “pullout”, i.e. this is the length of the section of threadlines pulled out during the test.
2. Edgecomb resistance testing is done on 5 warp direction & 5 weft direction specimens cut from each test fabric in a diagonal cross pattern & avoiding any areas within 200 mm of the fabric selvedges.

The warp direction edgecomb resistance results are obtained from tested specimens where warp threadlines are being pulled out, whilst weft direction results are obtained from tested specimens where the weft threadlines are being pulled out.

The reported result for warp edgecomb resistance is the mean average of the edgecomb resistance results of the five warp direction specimens in Newtons (N), whilst for weft edgecomb resistance it is the mean average of the results of the five weft direction specimens.

Stiffness (Stiffness of fabric by the circular bend procedure)—in Newtons (N) is tested using a J. A. King pneumatic stiffness tester according to standard ASTM D4032 but with the amendments as listed below:
1. The plunger stroke speed is 2000 mm/min
2. Stiffness testing is done on 5 warp direction & 5 weft direction specimens cut from each test fabric in a diagonal cross pattern & avoiding any areas within 200 mm of the fabric selvedges.
3. Each 200×100 mm specimen is single folded across the narrow dimension before being placed on the instrument testing platform for testing
4. The reported result (in Newtons) for warp stiffness is the mean average of the stiffness results of the five warp direction specimens whilst the result for weft stiffness is the mean average of the five weft direction specimens.

The Warp direction stiffness results are obtained from tested specimens where the longest dimension (200 mm) is parallel to the fabric warp direction, whilst weft direction results are obtained from tested specimens where the longest dimension (200 mm) is parallel to the fabric weft direction.

### Example 1

Nylon 6,6 polymer yarns with the following properties: 470 decitex, 136 Filament (fiber) and 81 cN/tex tenacity, were woven in the warp direction and weft direction on a water jet loom to produce a fabric of 205×195 threadline/dm construction and 210 gm⁻² weight (sample 1). The fabric was treated to wet calendering processes at previously disclosed calender conditions which do not lead to a reduction in fabric tenacity (sample 2), and to a higher temperature which results in partial melting and fusion of warp and weft threadlines at their intersections on the top and the bottom surface of the fabric (sample 3). The fabric was treated on both the top and bottom surface by passing twice through a calendering machine with heated roll. The fabric was pre-treated by a water spray system to give a uniform 15% by weight water concentration across the top and bottom surfaces of the fabric. The process the conditions for the two treated fabrics were as follows: 43 MPa pressure via a calender nip roll with force 300 N/mm of fabric width, with the heated roll at 168° C. and 205° C., at 15 m/min process speed.

Table 1 shows physical property data for the 3 fabrics.

TABLE 1

| | Treatment | | |
|---|---|---|---|
| | | HTHP | HTHP |
| | | Treated | Treated |
| | None | at 168° C. | at 205° C. |
| | Sample | | |
| | 1 | 2 | 3 |
| Fabric weight (g/m²) | 210 | 217 | 219 |
| Construction (ends/dm) | 205 × 195 | 209 × 198 | 210 × 198 |
| warp × weft | | | |
| Warp tensile test breaking | 3618 | 3622 | 2519 |
| force (N) | | | |
| Weft tensile test breaking | 3611 | 3616 | 2316 |
| force (N) | | | |
| Warp tensile test extension to | 37 | 38 | 30 |
| break (%) | | | |
| Weft tensile test extension to | 30 | 33 | 22 |
| break (%) | | | |
| Warp tear strength (N) | 171 | 162 | 77 |
| Weft tear strength (N) | 181 | 161 | 73 |
| Warp edgecomb resistance (N) | 585 | 647 | 955 |
| Weft edgecomb resistance (N) | 689 | 776 | 905 |
| Warp King stiffness (N) | 18 | 21 | 29 |
| Weft King stiffness (N) | 19 | 23 | 31 |
| Static air permeability (corrected) | 1.65 | 0.14 | 0.07 |
| at 500 Pa (l/dm²/min) | | | |
| Dynamic air permeability (mm/s) | 442 | 90 | 0 (no reading) |
| Thickness (mm) | 0.31 | 0.25 | 0.25 |

Sample 1 is the fabric which has received no HTHP treatment. Comparatively, it has a high tensile and tear strength, a moderate edge comb resistance strength, moderate stiffness, and high static and dynamic permeability. Sample 2 is HTHP treated with conditions which result in significantly lower static and dynamic permeability but maintain fabric tensile strength. The fabric is stiffer, thinner and has a moderately increased edge comb resistance strength in comparison to the untreated fabric. Sample 3 is HTHP treated with enhanced conditions which lead to a different set of properties to sample 2. The static and dynamic permeability of the fabric is essentially zero, and the edge comb resistance strength is significantly higher. The fabric tensile strength is reduced, but still remains a comparatively ‘strong’ fabric, the tear strength is reduced, and the stiffness is further increased.

FIGS. 1A through 1D are SEM images at ca, 15× and 40× magnification comparing the surfaces and cross section of a non-treated and HTHP treated fabric woven from 100% nylon 66 fabric made from 470 dtex, 136 filament, high tenacity yarn. FIG. 1A is untreated and the warp and weft threadlines, and the filaments (fibers) within the threadlines remain separate and discrete. FIG. 1B through 1D are SEM images of the same fabric following HTHP treatment to prior art conditions which result in a reduction of permeability but maintain fabric tensile strength. The fabric surface fibers are modified to have a flattened cross section and at least a portion of the fibers are fused together. The intersections warp and weft threadlines are significantly closed but remain discrete. The cross section of the fabric (FIG. 1D) shows surface flattening of the fibers and maintains discrete mainly circular cross section fibers within the fabric.

FIGS. 2A through 2D are SEM images at ca. 15 to 200× magnifications showing the surface and cross-sectional structure of the fabric ‘sample 3’ which has been HTHP treated at enhanced conditions to minimize permeability and maximize edge comb resistance strength. FIG. 2A shows that the entire fabric surface has warp and weft threadlines which are fused together at their intersections. There is also more significant fusing together of individual surface fibers within the threadlines. This results in reduced fabric permeability. FIG. 2B shows detail of the fabric surface structure where fibrillous or apical structures extend approximately normal to the surface of the fabric, and detail of the melt fusion occurring at the warp and weft threadline intersection which results in greater force being required to move the warp and weft threadlines relative to each other. FIG. 2C shows that there is some fusion of fibers at the interstices between the warp and weft threadlines. FIG. 1D shows the fabric cross sectional structure which has flattened and fused surfaces and highly compacted but still discrete fibers within the fabric. The fabric's structure and morphology are consistent with the physical properties—minimised permeability, greater resistance to warp and weft threadline relative movement, higher edge comb resistance due to the partial fusion of warp and weft threadline, and maintenance of tensile strength>1000N by the fibers within the fabric which remain discrete and little modified by the enhanced HTHP process conditions.

### Example 2

Nylon 6,6 polymer yarns with the following properties: 350 decitex, 136 Filament and 81 cN/tex tenacity, were woven in the warp direction and weft direction on a water jet loom to produce a fabric of 212×213 threadline/dm construction and 163 gm⁻² weight (sample 4). The fabric was treated to wet calendering processes at previously disclosed calender conditions which do not lead to a reduction in fabric tenacity (sample 5), and to a higher temperature which results in partial melting and fusion of warp and weft threadlines at their intersections on the top and the bottom surface of the fabric (sample 6). The fabric was treated on both the top and bottom surface by passing twice through a calendering machine with heated roll. The fabric was pre-treated by a water spray system to give a uniform 15% by weight water concentration across the top and bottom surfaces of the fabric. The process the conditions for the two treated fabrics were as follows: 43 MPa pressure via a calender nip roll with force 300 N/mm of fabric width, with the heated roll at 168° C. and 205° C., at 15 m/min process speed.

| | Treatment | | |
|---|---|---|---|
| | | HTHP | HTHP |
| | | Treated | Treated |
| | None | at 168° C. | at 205° C. |
| | Sample | | |
| | 4 | 5 | 6 |
| Fibre decitex | 350 | 350 | 350 |
| Fabric weight (g/m²) | 163 | 172 | 173 |
| Construction (ends/dm) warp × weft | 212 × 213 | 218 × 220 | 215 × 218 |
| Warp tensile test breaking force (N) | 2919 | 2941 | 1780 |
| Weft tensile test breaking force (N) | 2843 | 2839 | 1720 |
| Warp tensile test extension to | 30 | 34 | 26 |
| break (%) | | | |
| Weft tensile test extension to | 29 | 31 | 21 |
| break (%) | | | |
| Warp tear strength (N) | 132 | 118 | 60 |
| Weft tear strength (N) | 134 | 120 | 63 |
| Warp edgecomb resistance (N) | 541 | 604 | 675 |
| Weft edgecomb resistance (N) | 445 | 623 | 715 |
| Warp King stiffness (N) | 8 | 14 | 17 |
| Weft King stiffness (N) | 7 | 16 | 14 |
| Static air permeability (corrected) | 3.2 | 0.25 | 0.1 |
| at 500 Pa (l/dm²/min) | | | |
| Dynamic air permeability (mm/s) | 591 | 205 | 93 |
| Thickness (mm) | 0.24 | 0.18 | 0.18 |

Nylon 6,6 polymer yarns with the following properties: 470 decitex, 136 Filament and 81 cN/tex tenacity, were woven in the warp direction and weft direction on a water jet loom to produce a fabric of 169×165 threadline/dm construction and 172 gm⁻² weight (sample 7). The fabric was treated to wet calendering processes at previously disclosed calender conditions which do not lead to a reduction in fabric tenacity (sample 8), and to a higher temperature which results in partial melting and fusion of warp and weft threadlines at their intersections on the top and the bottom surface of the fabric (sample 9). The fabric was treated on both the top and bottom surface by passing twice through a calendering machine with heated roll. The fabric was pre-treated by a water spray system to give a uniform 15% by weight water concentration across the top and bottom surfaces of the fabric. The process the conditions for the two treated fabrics were as follows: 43 MPa pressure via a calender nip roll with force 300 N/mm of fabric width, with the heated roll at 168° C. and 205° C., at 15 m/min process speed.

| | Treatment | | |
|---|---|---|---|
| | | HTHP | HTHP |
| | | Treated | Treated |
| | None | at 168° C. | at 205° C. |
| | Sample | | |
| | 7 | 8 | 9 |
| Fibre decitex | 470 | 470 | 470 |
| Fabric weight (g/m²) | 172 | 180 | 183 |
| Construction (ends/dm) warp × weft | 169 × 165 | 174 × 171 | 175 × 171 |
| Warp tensile test breaking force (N) | 3025 | 3028 | 1901 |
| Weft tensile test breaking force (N) | 2875 | 2935 | 1734 |
| Warp tensile test extension to | 27 | 31 | 22 |
| break (%) | | | |
| Weft tensile test extension to | 27 | 31 | 23 |
| break (%) | | | |
| Warp tear strength (N) | 182 | 180 | 85 |
| Weft tear strength (N) | 187 | 185 | 85 |
| Warp edgecomb resistance (N) | 218 | 316 | 495 |
| Weft edgecomb resistance (N) | 200 | 396 | 527 |
| Warp King stiffness (N) | 5 | 12 | 15 |
| Weft King stiffness (N) | 6 | 13 | 15 |
| Static air permeability (corrected) | 6.0 | 0.5 | 0.30 |
| at 500 Pa (l/dm²/min) | | | |
| Dynamic air permeability (mm/s) | 600 | 186 | 128 |
| Thickness (mm) | 0.26 | 0.18 | 0.19 |

Nylon 6,6 polymer yarns with the following properties: 470 decitex, 136 Filament and 81 cN/tex tenacity, were woven in the warp direction and weft direction on a water jet loom to produce a fabric of 180×181 threadline/dm construction and 187 g/m² weight (sample 10). The fabric was treated to wet calendering processes at previously disclosed calender conditions which do not lead to a reduction in fabric tenacity (sample 11), and to a higher temperature which results in partial melting and fusion of warp and weft threadlines at their intersections on the top and the bottom surface of the fabric (sample 12). The fabric was treated on both the top and bottom surface by passing twice through a calendering machine with heated roll. The fabric was pre-treated by a water spray system to give a uniform 15% by weight water concentration across the top and bottom surfaces of the fabric. The process the conditions for the two treated fabrics were as follows: 43 MPa pressure via a calender nip roll with force 300 N/mm of fabric width, with the heated roll at 168° C. and 205° C., at 15 m/min process speed.

| | Treatment | | |
|---|---|---|---|
| | | HTHP | HTHP |
| | | Treated | Treated |
| | None | at 168° C. | at 205° C. |
| | Sample | | |
| | 10 | 11 | 12 |
| Fibre decitex | 470 | 470 | 470 |
| Fabric weight (g/m²) | 187 | 197 | 198 |
| Construction (ends/dm) warp × weft | 180 × 181 | 185 × 187 | 183 × 188 |
| Warp tensile test breaking force (N) | 3282 | 3278 | 2040 |
| Weft tensile test breaking force (N) | 3215 | 3269 | 2075 |
| Warp tensile test extension to | 32 | 35 | 26 |
| break (%) | | | |
| Weft tensile test extension to | 29 | 33 | 22 |
| break (%) | | | |
| Warp tear strength (N) | 168 | 167 | 82 |
| Weft tear strength (N) | 180 | 170 | 84 |
| Warp edgecomb resistance (N) | 347 | 446 | 636 |
| Weft edgecomb resistance (N) | 463 | 553 | 737 |
| Warp King stiffness (N) | 9.1 | 18 | 22 |
| Weft King stiffness (N) | 11 | 17 | 20 |
| Static air permeability (corrected) | 3 | 0.3 | 0.1 |
| at 500 Pa (l/dm²/min) | | | |
| Dynamic air permeability (mm/s) | 480 | 176 | 84 |
| Thickness (mm) | 0.28 | 0.20 | 0.21 |

Nylon 6,6 polymer yarns with the following properties: 470 decitex, 136 Filament and 81 cN/tex tenacity, were woven in the warp direction and weft direction on a water jet loom to produce a fabric of 195×195 threadline/dm construction and 202 gm⁻² weight (sample 13). The fabric was treated to wet calendering processes at previously disclosed calender conditions which do not lead to a reduction in fabric tenacity (sample 14), and to a higher temperature which results in partial melting and fusion of warp and weft threadlines at their intersections on the top and the bottom surface of the fabric (sample 15). The fabric was treated on both the top and bottom surface by passing twice through a calendering machine with heated roll. The fabric was pre-treated by a water spray system to give a uniform 15% by weight water concentration across the top and bottom surfaces of the fabric. The process the conditions for the two treated fabrics were as follows: 43 MPa pressure via a calender nip roll with force 300 N/mm of fabric width, with the heated roll at 168° C. and 205° C., at 15 m/min process speed.

| | Treatment | | |
|---|---|---|---|
| | | HTHP | HTHP |
| | | Treated | Treated |
| | None | at 168° C. | at 205° C. |
| | Sample | | |
| | 13 | 14 | 15 |
| Fibre decitex | 470 | 470 | 470 |
| Fabric weight (g/m²) | 202 | 211 | 212 |
| Construction (ends/dm) warp × weft | 195 × 195 | 198 × 199 | 198 × 198 |
| Warp tensile test breaking force (N) | 3573 | 3563 | 2467 |
| Weft tensile test breaking force (N) | 3484 | 3534 | 2284 |
| Warp tensile test extension to | 35 | 37 | 27 |
| break (%) | | | |
| Weft tensile test extension to | 29 | 33 | 23 |
| break (%) | | | |
| Warp tear strength (N) | 172 | 164 | 81 |
| Weft tear strength (N) | 179 | 170 | 84 |
| Warp edgecomb resistance (N) | 453 | 624 | 814 |
| Weft edgecomb resistance (N) | 538 | 700 | 789 |
| Warp King stiffness (N) | 15 | 26 | 28 |
| Weft King stiffness (N) | 16 | 28 | 28 |
| Static air permeability (corrected) | 2.30 | 0.20 | 0.12 |
| at 500 Pa (l/dm²/min) | | | |
| Dynamic air permeability (mm/s) | 391 | 102 | 79 |
| Thickness (mm) | 0.30 | 0.22 | 0.23 |

### Examples of Process Conditions which do not Result in the Preferred and Most Desirable Permeability and Tear Strength Properties

Nylon 6,6 polymer yarns with the following properties: 470 decitex, 136 Filament and 81 cN/tex tenacity, were woven in the warp direction and weft direction on a water jet loom to produce a fabric of 169×165 threadline/dm construction and 172 gm⁻² weight (sample 7). The fabric (sample 16) was treated to wet calendering processes was treated on both the top and bottom surface by passing twice through a calendering machine with heated roll. The fabric was pre-treated by a water spray system to give a uniform 15% by weight water concentration across the top and bottom surfaces of the fabric. The process conditions for the two treated fabrics were as follows: 43 MPa pressure via a calender nip roll with force 300 N/mm of fabric width, with the heated roll at 200° C., at 15 m/min process speed.

Nylon 6,6 polymer yarns with the following properties: 470 decitex, 136 Filament and 81 cN/tex tenacity, were woven in the warp direction and weft direction on a water jet loom to produce a fabric of 210×195 threadline/dm construction and 215 gm² weight. The fabric (sample 17) was treated to wet calendering processes was treated on both the top and bottom surface by passing twice through a calendering machine with heated roll. The fabric was pre-treated by a water spray system to give a uniform 15% by weight water concentration across the top and bottom surfaces of the fabric. The process conditions for the two treated fabrics were as follows: 43 MPa pressure via a calender nip roll with force 300 N/mm of fabric width, with the heated roll at 225° C., at 15 m/min process speed.

Fabric 16 has a static air permeability above the preferred target range and so was not further tested.

Fabric 17 has a weft tear strength below the preferred target range.

| | Treatment | |
|---|---|---|
| | HTHP | HTHP |
| | Treated | Treated |
| | at 200° C. | at 225° C. |
| | Sample | |
| | 16 | 17 |
| Fibre decitex | 470 | 470 |
| Fabric weight (g/m²) | 180 | 222 |
| Construction (ends/dm) warp × weft | 174 × 172 | 215 × 198 |
| Warp tensile test breaking force (N) | 1797 | 1950 |
| Weft tensile test breaking force (N) | | 1819 |
| Warp tensile test extension to break (%) | 27 | 29 |
| Weft tensile test extension to break (%) | | 21 |
| Warp tear strength (N) | | 65 |
| Weft tear strength (N) | | 54 |
| Warp edgecomb resistance (N) | | 927 |
| Weft edgecomb resistance (N) | | 905 |
| Warp King stiffness (N) | | 38 |
| Weft King stiffness (N) | | 37 |
| Static air permeability (corrected) | 0.45 | 0.03 |
| at 500 Pa (l/dm²/min) | | |
| Dynamic air permeability (mm/s) | | 0 (no reading) |
| Thickness (mm) | | 0.24 |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include±1%, ±2%, ±3%, ±4%, ±5%, ±8%, or ±10%, of the numerical value(s) being modified. In addition, the phrase “about ‘x’ to ‘y’” includes “about ‘x’ to about ‘y’”. While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

1. An uncoated woven fabric comprising yarn formed from synthetic fiber woven in the warp direction and weft direction to form a top surface and a bottom surface, the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

2. An uncoated woven fabric according to claim 1 wherein the warp yarn is different from the weft yarn by virtue of one or more differences in their physical properties derived from one or more differences in the physical properties of said synthetic fiber, wherein the fibers which form the warp yarn are chemically identical to the fibers which form the weft yarn.

3. An uncoated woven fabric according to claim 2 wherein the fibers which form the warp yarn are formed from a single polymer which is the same as the single polymer from which the fibers of the weft yarn are formed

4. An uncoated woven fabric according to claim 1 wherein the wherein the warp yarn is different from the weft yarn in that the chemical composition of the synthetic fibers of the warp yarn is different from the chemical composition of the synthetic fibers of the weft yarn, wherein warp and weft yarns are made from the same class of polymer, and wherein the polymeric materials which form the fibers of the warp and weft yarns exhibit a single melting phase.

5. An uncoated woven fabric according to claim 1 comprising yarn formed from fibers of the same synthetic fiber formed from a single polymer, woven in the warp direction and weft direction to form a top surface and a bottom surface, the fabric surface structure has fibrillous or apical structures extending approximately normal to the surface of the fabric, and at least a portion of the yarn on the top surface and/or at least a portion of the yarn on the bottom surface has warp and weft fibers which are melt fused together at their intersections, and a majority of the yarn on the top surface and/or a majority of the yarn on the bottom surface has fibers with a permanently modified cross-section that are fused together; wherein a permanently modified cross-section means a fiber cross section that is a modified or compressed version of the cross section of the majority of the fiber used in the fabric.

6. An uncoated woven fabric according to claim 5 wherein the warp yarn and the weft yarn are made from identical yarn.

7. An uncoated woven fabric according to claim 5 wherein the warp yarn is formed from synthetic fibers which are the same as the synthetic fibers from which the weft yarn is formed, and wherein the warp yarn is different from the weft yarn by virtue in that the warp and weft yarn exhibit one or more differences in their physical properties.

8. An uncoated woven fabric according to claim 1 which exhibits a static air permeability (SAP) of 0.3 1/dm²/min or lower, preferably 0.21/dm²/min or lower, and a dynamic air permeability of 150 mm/sec or lower; and a tensile strength of the fabric in both the warp and weft directions of 1000 N or greater.

9. An uncoated woven fabric comprising yarn formed from fibers of the same synthetic fiber formed from a single polymer, woven in the warp direction and weft direction to form a top surface and a bottom surface; wherein the fabric has a static air permeability (SAP) of 0.3 1/dm²/min or lower, preferably 0.2 1/dm²/min or lower, and the dynamic air permeability is 150 mm/sec or lower; wherein the tensile strength of the fabric in both the warp and weft directions is 1000 N or greater; wherein a 15-200× magnified image of the fabric surface structure shows fibrillous or apical structures extending approximately normal to the surface of the fabric.

10. An uncoated woven fabric according to claim 9 wherein the warp and weft fibers are melt fused together at their intersections on the top and/or the bottom surface of the fabric, and a majority of the yarn on the top surface and/or a majority of the yarn on the bottom surface have fibers with a permanently modified cross-section that are fused together; wherein a permanently modified cross-section means a fiber cross section that is a modified or compressed version of the cross section of the majority of the fiber used in the fabric.

11. The uncoated woven fabric of claim 9 wherein fibers of said woven fabric have a permanently modified cross-section.

12. The uncoated woven fabric of claim 9, wherein the permanently modified cross-section results in at least a portion of the fiber being substantially flat.

13. An uncoated woven fabric according to claim 11 wherein the edge comb resistance strength of the fabric in both the warp and weft directions is 400N or greater.

14. An uncoated woven fabric according to claim 11, wherein the basis weight of the fabric is in the range from 50 to 500 g/m².

15. An uncoated woven fabric according to claim 11, wherein said polymer is a polyamide, preferably nylon.

16. The uncoated woven fabric of claim 11 wherein the yarn has a linear density in the range from about 150 to about 2000 decitex.

17. The uncoated woven fabric of claim 11 wherein the tear strength of the fabric in both the warp and weft directions is 60 N or greater.

18. The uncoated woven fabric of claim 11 wherein the fibers have a density in the range from about 1 to about 25 decitex per filament (DPF).

19. The uncoated woven fabric of claim 11 wherein said apical structures are disposed at least along the intersections of the warp yarn with the weft yarn, preferably such that an intersection exhibits one or more apical structure(s) along at least 80% of its length, and wherein at least 80% of all intersections on the or each surface of said woven fabric exhibits apical structures in such a way.

20. The uncoated woven fabric of claim 19 wherein said apical structures are also disposed in a ring-like formation around a junction of said intersections, wherein at least 80% of all junctions on one surface of said fabric exhibit such ring-like apical structures.

21. The uncoated woven fabric of claim 20 wherein said apical structures exhibit a height distribution such that of the apical structures above the 50th percentile, at least 70% of all apical structures on a surface of the fabric are located along said intersections or in ring-like formations around said junctions.

22. The uncoated woven fabric of claim 21 wherein at least 70% of all apical structures on a surface of the fabric are located along said intersections or in ring-like formations around said junctions.

23.-27. (canceled)

28. A method of forming an uncoated woven fabric as defined in claim 1, the method comprising;
a. weaving yarn formed from the same synthetic fibers, formed from a single polymer, in the warp direction and weft direction to form a fabric with a top surface and a bottom surface;
b. treating the fabric in order to permanently modify the fabric surface structure such that fibrillous or apical structures extend approximately normally to the surface of the fabric;
such that at least a portion of the yarn on the top surface and/or at least a portion of the yarn on the bottom surface have warp and weft fibers which are melt fused together at their intersections, and a majority of the yarn on the top surface and/or a majority of the yarn on the bottom surface have fibers with a permanently modified cross-section that are fused together.

29.-49. (canceled)
